(19) United States
(12) Patent Application Publication
(10) Pub. No.: US 2022/0405033 A1
(43) Pub. Date: Dec. 22, 2022

(54) INFORMATION PROCESSING APPARATUS, INFORMATION PROCESSING SYSTEM, AND INFORMATION PROCESSING METHOD

(71) Applicant: Taichi Watanabe, Kanagawa (JP)

(72) Inventor: Taichi Watanabe, Kanagawa (JP)

(73) Assignee: Ricoh Company, Ltd., Tokyo (JP)

(21) Appl. No.: 17/806,544

(22) Filed: Jun. 13, 2022

(30) Foreign Application Priority Data
Jun. 22, 2021 (JP) 2021-103446

(51) Int. Cl. G06F 3/12

(52) U.S. Cl. CPC G06F 3/1275; G06F 3/1203

(57) ABSTRACT

An information processing apparatus, an information processing system, and an information processing method. The information processing apparatus receives from a device communicably connected to the information processing apparatus through a network, an execution request for a first processing unit of an ordered set of one or more processing units in a workflow, the execution request indicating change in processing based on multiple device types classified by function, controls execution of the workflow in response to the execution request, and changes the processing to be executed for the first processing unit based on the device type to which the device belongs.

### CROSS-REFERENCE TO RELATED APPLICATIONS

This patent application is based on and claims priority pursuant to 35 U.S.C. § 119(a) to Japanese Patent Application No. 2021-103446, filed on Jun. 22, 2021, in the Japan Patent Office, the entire disclosure of which is hereby incorporated by reference herein.

### BACKGROUND

### Technical Field

The present disclosure relates to an information processing apparatus, an information processing system, and an information processing method.

### Related Art

An information processing system that executes a process such as a predefined workflow in response to a request from a client connected through a network is known. For example, in an information processing system, an image forming apparatus may execute the process on scanned data, or the image forming apparatus may download and print a result of executing the process on data stored in a cloud storage or the like.

In such information processing system, in addition to the image forming apparatus, a plurality of types of devices such as a personal computer (PC), a mobile terminal, and an electronic whiteboard may be used as the client. In this case, the user can execute the same workflow by using such various devices.

### SUMMARY

Embodiments of the present disclosure describe an information processing apparatus, an information processing system, and an information processing method. The information processing apparatus receives from a device communicably connected to the information processing apparatus through a network, an execution request for a first processing unit of an ordered set of one or more processing units in a workflow, the execution request indicating change in processing based on multiple device types classified by function, controls execution of the workflow in response to the execution request, and changes the processing to be executed for the first processing unit based on the device type to which the device belongs.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a configuration of an information processing system according to embodiments of the present disclosure;

FIG. 2 is a diagram illustrating a hardware configuration of an information processing apparatus according to embodiments of the present disclosure;

FIG. 3 is a diagram illustrating an example of a hardware configuration of a device according to embodiments of the present disclosure;

FIG. 4 is a diagram illustrating an example of a functional configuration of the information processing system according to embodiments of the present disclosure;

FIG. 5 is a sequence diagram illustrating an example of a workflow information generation process;

FIG. 6 is a diagram illustrating an example of a workflow generation screen;

FIG. 7 is a diagram illustrating an example of a setting screen related to a standby component;

FIGS. 8 and 9 are a diagram illustrating an example of workflow information;

FIG. 10 is a sequence diagram illustrating an example of a process executed in response to a user using any of one or more workflows;

FIG. 11 is a flowchart illustrating an example of a screen information generation process;

FIG. 12 is a diagram illustrating an example of screen data;

FIG. 13 is a flowchart illustrating an example of a screen display process;

FIG. 14 is a diagram illustrating an example of an error screen;

FIG. 15 is a diagram illustrating an example of a screen based on screen configuration information;

FIG. 16 is a diagram illustrating an example of a screen for receiving an execution instruction after standby;

FIG. 17 is a flowchart illustrating an example of a workflow execution control process;

FIG. 18 is a diagram illustrating an example of a standby workflow list screen; and

FIG. 19 is a diagram illustrating an example of a cancellation workflow list screen.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings.

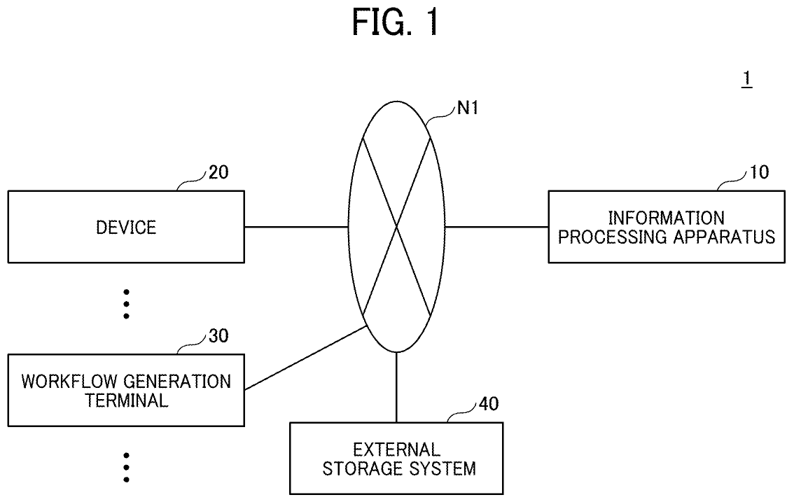

FIG. 1 is a diagram illustrating an example of a configuration of an information processing system 1 according to embodiments of the present disclosure. The information processing system 1 illustrated in FIG. 1 includes an information processing apparatus 10, one or more devices 20, one or more workflow generation terminals 30, an external storage system 40, and the like. The device 20, the external storage system 40, and the like are connected to the information processing apparatus 10 through a wide area network N1 such as the internet.

The information processing apparatus 10 is one or more computers that control execution of a processing workflow (hereinafter referred to as a “workflow”) which is a set of one or more processing units in order (referred to as an “ordered set of one or more processing units”).

Here, the processing unit is processing related to an electronic file such as a document file or an image file. For example, print, scan, facsimile transmission, data format conversion, email transmission, optical character recognition (OCR) process, data processing, compression and decompression, storage in a repository, and the like are examples of the processing units. A process defined as the processing unit is determined by a developer.

The device 20 is an electronic device that functions as an input source of data to be processed in the workflow or an output destination of data generated as a result of processing of the workflow. For example, an image forming apparatus such as a multifunction peripheral (MFP), a personal computer (PC), a smartphone, a tablet terminal, a projector, an electronic whiteboard, a digital camera and the like are examples of the device 20.

The workflow generation terminal 30 is a terminal such as the PC used for generating workflow definition information (information indicating order of execution of processing units). Workflow definition information (hereinafter referred to as “workflow information”) is generated for each type of workflow. In addition, any device 20 or each device 20 may also serve as the workflow generation terminal 30.

The external storage system 40 is one or more storage devices that provide a cloud storage. In the present embodiment, the external storage system 40 is a candidate for a storage destination of data generated in the workflow.

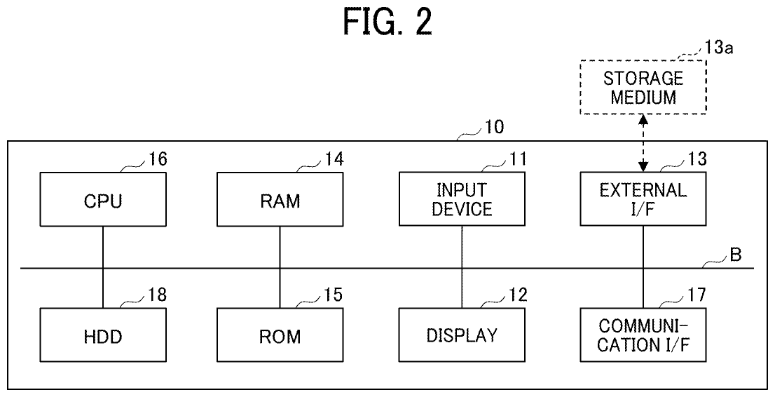

FIG. 2 is a diagram illustrating a hardware configuration of the information processing apparatus 10 according to the embodiments of the present disclosure. The information processing apparatus 10 illustrated in FIG. 2 includes an input device 11, a display 12, an external interface (I/F) 13, and a random access memory (RAM) 14. Further, the information processing apparatus 10 includes a read only memory (ROM) 15, a central processing unit (CPU) 16, a communication I/F 17, and a hard disk drive (HDD) 18. These hardware devices are connected to one another through a bus B.

The input device 11 includes a keyboard, a mouse, a touch panel, and the like to enable the user to input various operational signals. The display 12 includes a display panel and the like and displays the processing result produced by the information processing apparatus 10. Note that at least one of the input devices 11 and the display 12 may be connected to the information processing apparatus 10 when in use.

The communication I/F 17 is an interface device to connect the information processing apparatus 10 to the network N1. The information processing apparatus 10 performs communication through the communication I/F 17.

The HDD 18 is a nonvolatile storage device that stores programs and data. Examples of the programs and data stored in the HDD 18 include an operating system (OS) for controlling an entire operation of the information processing apparatus 10 and an application program providing various functions on the OS.

The information processing apparatus 10 may use a drive device (for example, a solid state drive (SSD)) that uses a flash memory as a storage medium instead of the HDD 18. Further, the HDD 18 manages the stored programs and data by a specific file system and/or specific database (DB).

The external I/F 13 is an interface for an external device. Examples of the external device include a storage medium 13a. Accordingly, the information processing apparatus 10 can read from and write to the storage medium 13a through the external I/F 13. Examples of the storage medium 13a include a flexible disc, a Compact Disc (CD), a Digital Versatile Disc (DVD), a Secure Digital (SD) memory card, and a Universal Serial Bus (USB) memory.

The ROM 15 is a nonvolatile semiconductor memory that can hold programs and data even when the power is turned off. The ROM 15 stores programs and data such as Basic Input/Output System (BIOS), OS settings, network settings, and the like, which are executed at the time of activation of the information processing apparatus 10. The RAM 14 is a volatile semiconductor memory that temporarily stores programs and data.

The CPU 16 reads programs or data from a storage device such as the ROM 15 and the HDD 18 onto the RAM 14 and executes processing to implement entire control and functions of the information processing apparatus 10.

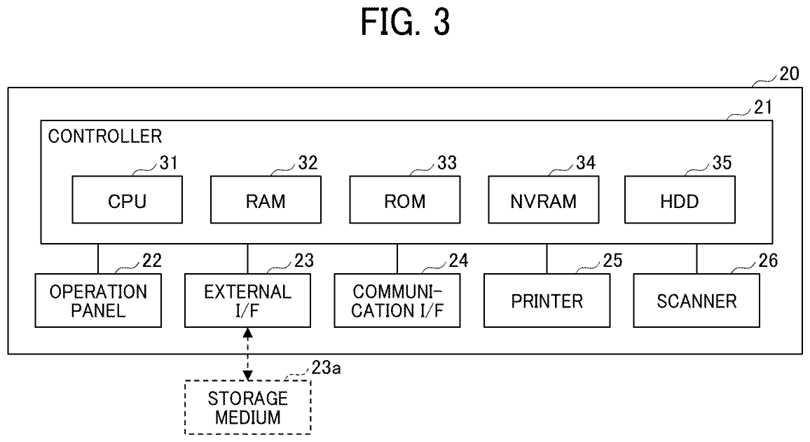

FIG. 3 is a diagram illustrating an example of a hardware configuration of the device 20 according to embodiments of the present disclosure.

The device 20 illustrated in FIG. 3 includes a controller 21, an operation panel 22, an external I/F 23, a communication I/F 24, a printer 25, and a scanner 26. Further, the controller 21 includes a CPU 31, a RAM 32, a ROM 33, a nonvolatile random access memory (NVRAM) 34, and an HDD 35.

The ROM 33 is the nonvolatile semiconductor memory that stores various programs or data. The RAM 32 is the volatile semiconductor memory, which holds programs or data temporarily. The NVRAM 34 stores, for example, setting information and the like. The HDD 35 is the nonvolatile storage device that stores various programs or data.

The CPU 31 is an arithmetic unit that implements control and functions of the entire device 20 by reading programs, data, setting information, and the like from the ROM 33, NVRAM 34, HDD 35, and the like onto the RAM 32 and executing processing.

The operation panel 22 includes an input unit that receives user input, and a display unit that displays various information. The external I/F 23 is an interface with an external device. An example of the external device is a storage medium 23a. Accordingly, the device 20 can read from and write to the storage medium 23a through the external I/F 23. Examples of the storage medium 23a include an integrated circuit (IC) card, the flexible disc, the CD, the DVD, the SD memory card, and the USB memory.

The communication IX 24 is an interface for connecting the device 20 to the network. The device 20 performs communication through the communication I/F 24. The printer 25 is a printing device that prints print data. The scanner 26 is a scanning device that reads a document and generates an electronic file (image file).

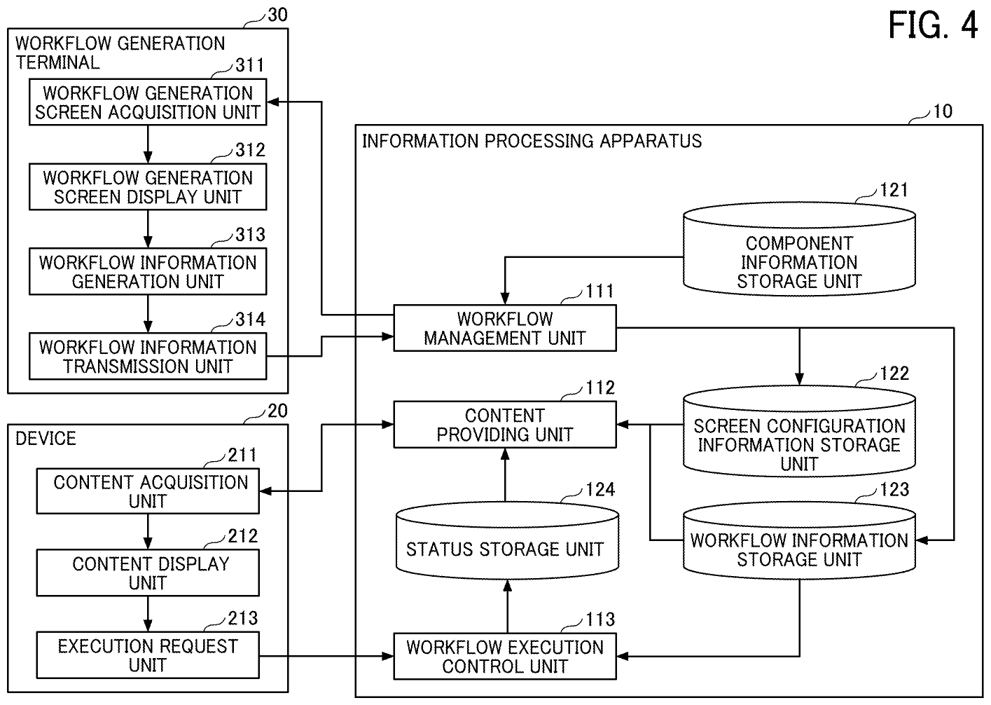

FIG. 4 is a diagram illustrating an example of a functional configuration of the information processing system 1 according to the embodiments of the present disclosure. In FIG. 4, the workflow generation terminal 30 includes a workflow generation screen acquisition unit 311, a workflow generation screen display unit 312, a workflow information generation unit 313, and a workflow information transmission unit 314. Each of these units is implemented by a process executed by the CPU of the workflow generation terminal 30 according to one or more programs installed in the workflow generation terminal 30.

The workflow generation screen acquisition unit 311 acquires screen data of a screen for editing and generating workflow information by the user (hereinafter referred to as “workflow generation screen”) from the information processing apparatus 10. The workflow generation screen display unit 312 displays the workflow generation screen based on the screen data of the workflow generation screen. The workflow information generation unit 313 generates workflow information according to input by the user on the workflow generation screen. The workflow information transmission unit 314 transmits the workflow information generated by the workflow information generation unit 313 to the information processing apparatus 10.

The device 20 includes a content acquisition unit 211, a content display unit 212, and an execution request unit 213. Each of these units is implemented by a process executed by the CPU 31 according to one or more programs installed or downloaded to the device 20. The program may include scripts downloaded by the browser.

The content acquisition unit 211 acquires content (information about the screen) related to the execution of workflow. The content display unit 212 displays a screen based on the content acquired by the content acquisition unit 211. In response to the input by the user on the screen displayed by the content display unit 212, the execution request unit 213 transmits a workflow execution request related to the screen to the information processing apparatus 10.

The information processing apparatus 10 includes a workflow management unit 111, a content providing unit 112, and a workflow execution control unit 113. Each of these units is implemented by a process executed by the CPU 16 according to one or more programs installed in the information processing apparatus 10. The information processing apparatus 10 also includes a component information storage unit 121, a screen configuration information storage unit 122, a workflow information storage unit 123, and a status storage unit 124. Each of these storage units is implemented by using, for example, the HDD 18 or a storage device that can be connected to the information processing apparatus 10 through the network.

The workflow management unit 111 generates screen data of the workflow screen with reference to the component information storage unit 121 and stores the workflow information transmitted from the workflow generation terminal 30 in the workflow information storage unit 123. The workflow information storage unit 123 stores a list of workflow information. The component information storage unit 121 stores information related to a component which is a part of program corresponding to any of the workflow components. The workflow is made up of components each corresponding one-to-one to a processing unit. The workflow management unit 111 generates information indicating configuration of a screen (hereinafter referred to as “screen configuration information”) for receiving a workflow execution instruction related to the workflow information based on the workflow information transmitted from the workflow generation terminal 30. The workflow management unit 111 stores the generated screen configuration information in the screen configuration information storage unit 122.

The content providing unit 112 provides (transmits) content related to the execution of the workflow to the device 20. The content providing unit 112 generates the content by referring to the screen configuration information storage unit 122, the workflow information storage unit 123, and the status storage unit 124.

The workflow execution control unit 113 controls the execution of the workflow in response to the workflow execution request from the device 20. In controlling the execution of the workflow, the workflow execution control unit 113 stores in the status storage unit 124, information related to the workflow in the specific state in response to the detection of a specific state of the workflow.

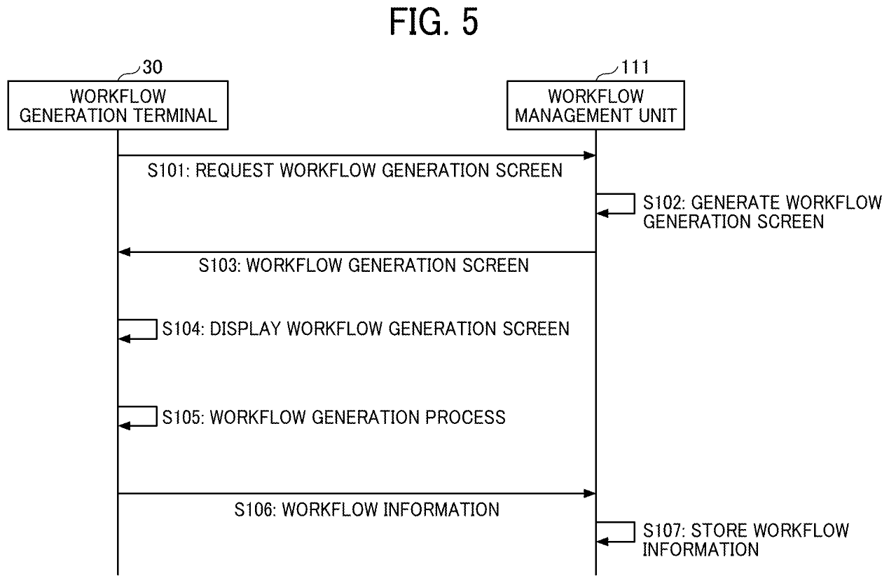

A process executed by the information processing system 1 is described in the following. FIG. 5 is a sequence diagram illustrating an example of a workflow information generation process.

In step S101, the workflow generation screen acquisition unit 311 transmits a workflow generation screen acquisition request to the workflow management unit 111 in response to a user operation on the workflow generation terminal 30.

In response to receiving the acquisition request, the workflow management unit 111 refers to the component information storage unit 121 and generates screen data of the workflow generation screen in step S102. The screen data is not limited to a specific format, but may be defined in, for example, HyperText Markup Language (HTML) and may include a program such as a script. The workflow management unit 111 refers to the component information storage unit 121 to generate the screen data in order to display a list of components as component options corresponding to each processing unit of the workflow in generating the workflow information. In step S103, the workflow management unit 111 transmits the screen data to the workflow generation screen acquisition unit 311.

In response to receiving the screen data by the workflow generation screen acquisition unit 311, the workflow generation screen display unit 312 displays the workflow generation screen based on the screen data in step S104. In step S105, the workflow information generation unit 313 executes a workflow information generation process in response to an operation by the user on the workflow generation screen.

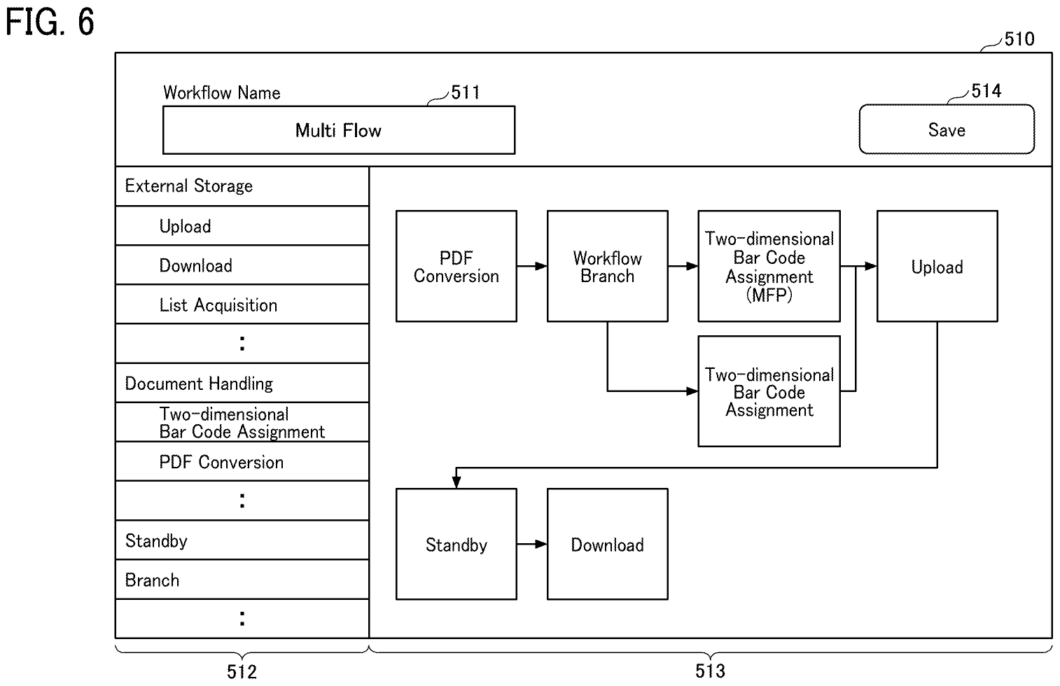

FIG. 6 is a diagram illustrating an example of the workflow generation screen. The workflow generation screen 510 illustrated in FIG. 6 includes a workflow name input area 511, a component list 512, a workflow editing area 513, a save button 514, and the like.

The workflow name input area 511 is an area for receiving input of a name (hereinafter referred to as a “workflow name”) for the workflow information.

The component list 512 is a list of components to be selected as components configuring the workflow to be generated. In the example of FIG. 6, components such as “upload”, “download”, and “list acquisition” are illustrated as examples of components related to the external storage. Components such as “two-dimensional bar code assignment”, “Portable Document Format (PDF) conversion” and the like are illustrated as examples of components related to document handling. Components such as “standby”, “branch” and the like are illustrated as examples of workflow control system components. The “standby” indicates to suspend (standby) the progress of processing at the time of a first execution request (workflow execution request) and to enable control such as executing the subsequent components after “standby” in response to a second execution request. The “branch” is a component for enabling a branch of the workflow.

The workflow editing area 513 is an area for editing the execution order (that is, workflow information) of the components selected from the component list 512.

The save button 514 is a button for receiving a save instruction of workflow information (hereinafter, referred to as “target workflow information”) in the workflow editing area 513.

The workflow editing area 513 in FIG. 6 illustrates a state in which editing of target workflow information has already been completed.

The target workflow information indicates image data uploaded from the device 20 is converted to PDF in response to a first execution instruction, a two-dimensional bar code assignment including specific information is assigned to the PDF data generated by the PDF conversion, the PDF data is uploaded to the external storage system 40 and stands by for a next instruction. The target workflow information further indicates that when the standby is released in response to the second execution request, the PDF data is downloaded from the external storage system 40 and transmitted to the device 20.

The user can set a value of a parameter specific to the component for each component arranged in the workflow editing area 513. For example, in the case of the upload component, the user can set information related to the external storage system 40 to upload.

Further, the user can set a branch condition for the branch component. The branch condition is a condition for determining the component at a branch destination. For example, a device type of the device 20 to which the execution request source of the workflow related to the target workflow information (hereinafter referred to as a “target workflow”) belongs can be designated as the branch condition. The branch destination can be changed according to the device type. The device type is information indicating classification or type of the device 20 having the same function, for example, the MFP that includes print and scan functions, the PC or the smartphone that do not include the print and scan functions but includes a display, and an electronic whiteboard that does not include the print and scan functions but includes a large display. In other words, the device type is information indicating which type the device 20 belongs to when the device 20 is classified into a plurality of types according to the functions of the device 20. In the example of FIG. 6, the target workflow is generated so that the setting value for the “two-dimensional bar code assignment” component differs depending on whether the device type is the MFP or not.

Changes in processing based on the device type can also be designated for other components.

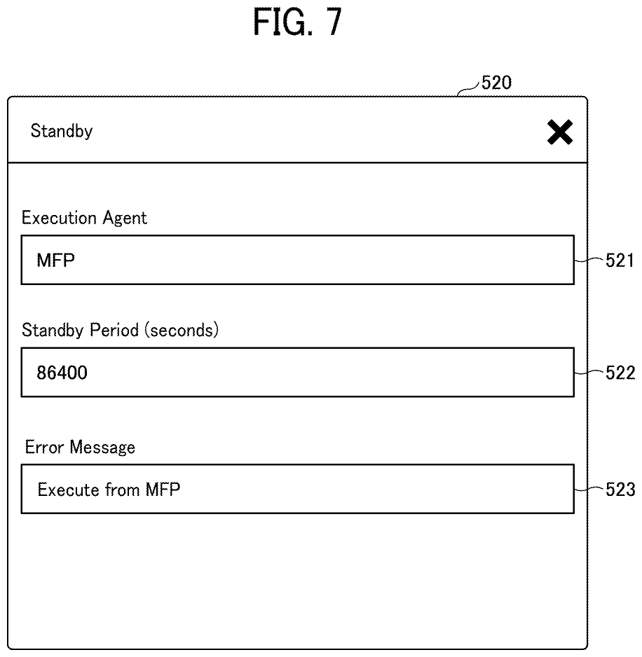

FIG. 7 is a diagram illustrating an example of a setting screen related to the standby component. The setting screen 520 illustrated in FIG. 7 includes setting areas 521 to 523 for setting parameters for the standby component. The setting area 521 is an area for receiving the setting of an execution agent. The execution agent refers to the device type of the device 20 that is the execution request source of the target workflow. The example of FIG. 7 illustrates an example in which “MFP” is set as the execution agent.

This indicates that the ability to release the standby state (the process that can proceed to the next component of the standby component) is limited to the device 20 whose device type is MFP. Note that the execution agent may be configurable for components other than the standby component.

The setting area 522 is an area for receiving the setting of a standby period (seconds). The standby period is the time from when the standby component is targeted for execution (that is, the timing when the standby of the target workflow is started) to the end of the standby during execution of the target workflow. The user is to give a second execution instruction for the target workflow from any device 20 during the standby period. The device 20 for which the user inputs the second execution instruction does not have to be the same device 20 for which the user inputted the first execution instruction.

The setting area 523 is an area for receiving the setting of the error message to be displayed for the device 20 which is the source of the second execution request, in the case the device type of the device 20 which is the source of the second execution request is not the device type designated as the execution agent (MFP in the example of FIG. 7).

Although FIG. 7 illustrates an example of the setting screen for the standby component, parameters can be set according to the component for other components configuring the target workflow.

In step S105, the workflow information generation unit 313 updates the workflow information of the target workflow in response to interactive input by the user.

In response to the pressing of the save button 514 following the completion of the editing of the target workflow information, the workflow information transmission unit 314 transmits the workflow information of the target workflow to the workflow management unit 111 of the information processing apparatus 10 in step S106. In response to receiving the workflow information, the workflow management unit 111 stores the workflow information in the workflow information storage unit 123 in association with a workflow identifier (ID) in step S107. The workflow ID is identification information of the workflow information. The workflow ID may be generated by the workflow management unit 111 at this timing.

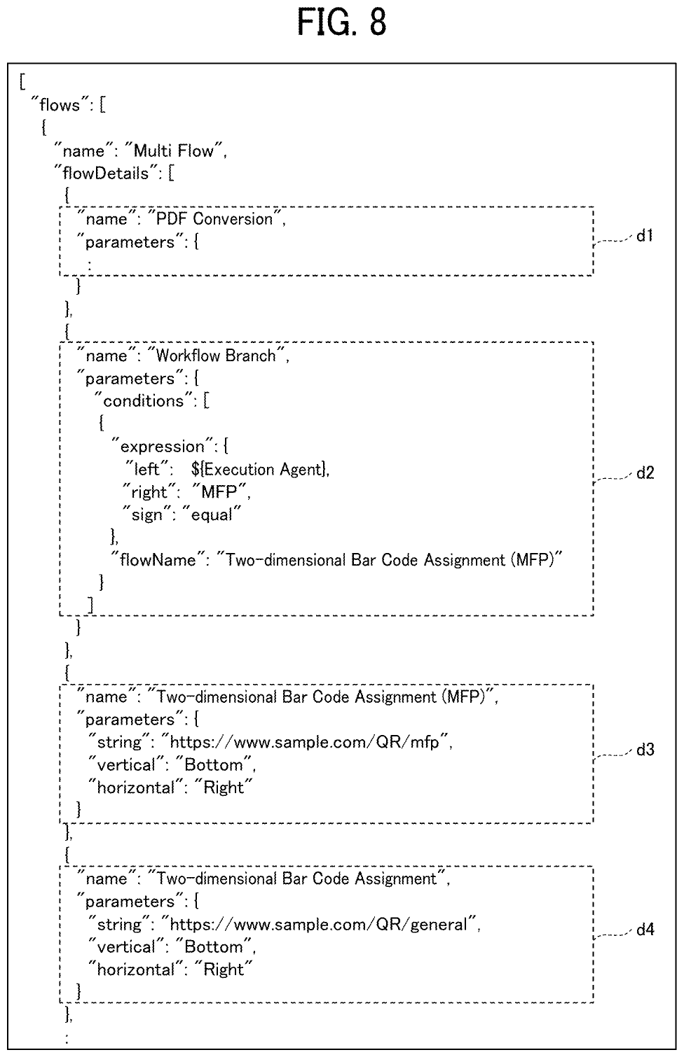

FIGS. 8 and 9 are diagrams illustrating a configuration example of the workflow information. FIG. 8 illustrates a part of the target workflow information from the beginning, and FIG. 9 illustrates the rest of the target workflow information. The two drawings, FIG. 8 and FIG. 9, illustrate one piece of target workflow information.

In FIGS. 8 and 9, component definition d1 to the component definition d6 are definitions for each component making up the target workflow. Specifically, the component definition d1 is a definition related to the PDF conversion component. The component definition d2 is a definition related to the branch component. The component definition d3 is a definition related to the two-dimensional bar code assignment component when the execution agent related to the first execution request is the MFP (hereinafter referred to as a “two-dimensional bar code assignment (MFP)” component). The component definition d4 is a definition related to the two-dimensional bar code assignment component when the execution agent related to the first execution request is other than the MFP. The component definition d5 is a definition related to the standby component. The component definition d6 is a definition related to the download component. Although FIG. 6 illustrates that the target workflow also includes the upload component, the component definition of the upload component is omitted.

Each component definition includes a name element (an element starting with “name”: and the same naming rule applies for other elements) and a parameters element. The value of the name element (a character string following “name”: and the same naming rule applies for other elements) indicates the component name of the component corresponding to each component definition. The parameters element contains the name and value of the parameter corresponding to the component to which each definition corresponds.

For example, the parameters element of the component definition d2 related to the branch component includes the conditions element indicating the branch condition as a child element. The expressions element includes an expression element and a flowName element as the child elements.

The expression element is an element indicating a conditional expression of the branch condition, and includes a left element, a right element, and a sign element. The value of the left element indicates the value on the left side of the conditional expression.

The value of the right element indicates the value on the right side of the conditional expression. The value of the sign element indicates a sign indicating the relationship between the left side and the right side of the conditional expression. As the sign, “equal”, “nequal”, “lt”, “ltoe”, and the like can be set. Equal indicates a relationship in which left (left side) and right (right side) match. Nequal indicates a relationship in which left (left side) and right (right side) do not match. Lt indicates a relationship in which left (left side) is smaller than right (right side). Ltoe indicates a relationship in which left (left side) is less than or equal to right (right side). The value of the left element of the expression element in the component definition d2 is “S {execution agent}”, the value of the right element is “MFP”, and the value of the sign element is “equal”. Here, “$ {execution agent}” indicates the device type as the execution agent. Accordingly, the expression element indicates a conditional expression that “the execution agent is equal to MFP”.

The flowName element is an element whose value is the component name of the branch destination selected when the conditional expression is satisfied. In the example of FIG. 8, the value of the flowName element is a “two-dimensional bar code assignment (MFP)”.

From the above description, the branch condition in the component definition d2 indicates that in the case the execution agent is equal to MFP, the process proceeds to the “two-dimensional bar code assignment (MFP)”, and in the case the execution agent is not equal to MIT, the process proceeds to the “two-dimensional bar code assignment”.

The parameters element in the component definition d3 for the “two-dimensional bar code assignment (MFP)” component includes a string element, a vertical element, and a horizontal element. The value of the string element indicates a character string to be converted into the two-dimensional bar code. The vertical element indicates a position of the two-dimensional bar code in the vertical direction of a document. The horizontal element indicates the position of the two-dimensional bar code in the vertical direction of the document.

The configuration of the component definition d4 related to the “two-dimensional bar code assignment” component is the same as the component definition d3. Although the component names are different, the “two-dimensional bar code assignment (MFP)” component and the “two-dimensional bar code assignment” component are the same except for the parameter values. In the example of FIG. 8, the value of the string element is different between the “two-dimensional bar code assignment (MFP)” component and the “two-dimensional bar code assignment” component. The target workflow is configured so that the information (character string) to be embedded in the document as a two-dimensional bar code differs depending on whether the execution agent is the MFP or not.

The parameters element in the component definition d5 (FIG. 9) related to the standby component includes an execute element and an error element as the child elements. The execute element is an element indicating an execution condition. Specifically, the execute element includes a left element, a right element, a sign element, and a keepTime element as the child elements. The left element, the right element, and the sign element are as described for the expression elements of the component definition d2 (FIG. 8). In the case the conditional expressions indicated by the left element, the right element, and the sign element are satisfied, the “standby” component is executed. In the example of FIG. 9, the conditional expression indicates that “the execution agent is equal to MFP”. The execution agent corresponds to the device type of the device 20 that is the source of the second execution request after the start of standby. The value of the keepTime element indicates the standby period.

The value of the error element indicates the error message in the case the conditional expression of the execute element is not satisfied.

The content of the component definition d5 corresponds to the setting example for the setting screen 520 illustrated in FIG. 7.

The parameters element in the component definition d6 corresponding to the download component includes an execute element. The execute element is an element indicating an execution condition, and includes the left element, the right element, and the sign element as the child elements. In the case the conditional expressions indicated by the left element, the right element, and the sign element are satisfied, the download component is executed. In the example of FIG. 9, the conditional expression indicates that “the execution agent is equal to MFP”.

The workflow management unit 111 generates screen configuration information related to the target workflow based on the target workflow information and stores the screen configuration information in the screen configuration information storage unit 122 in association with the workflow ID of the target workflow. The screen configuration information refers to information indicating a screen configuration for receiving input of parameters related to the target workflow at the start of execution of the target workflow. In the target workflow in the present embodiment, the data uploaded from the device 20 is input and processed. Accordingly, the workflow management unit 111 generates the screen configuration information of the screen on which the upload target can be designated.

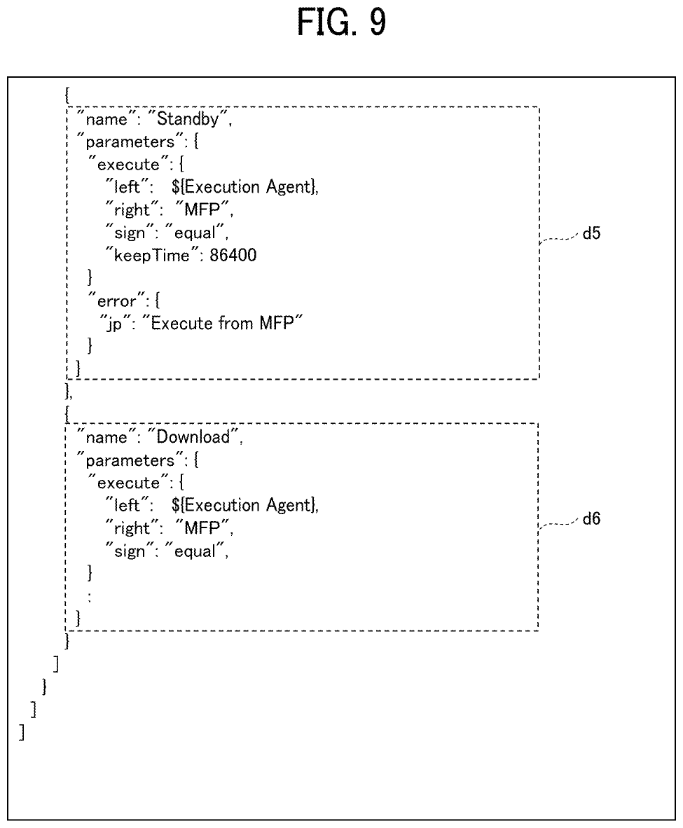

A process executed when the user uses one of the workflows is described in the following. FIG. 10 is a sequence diagram illustrating an example of the process executed in response to a user using any one of one or more workflows.

In response to an operation on the device 20 (hereinafter referred to as a “target device 20”) by the user, the content acquisition unit 211 of the target device 20 transmits an acquisition request of the workflow list screen to the information processing apparatus 10 in step S201. It is assumed that the user has logged in to the information processing apparatus 10 in advance.

In response to receiving the acquisition request, the content providing unit 112 of the information processing apparatus 10 refers to the workflow information storage unit 123 and generates screen data of the workflow list screen in step S202. For example, the content providing unit 112 may generate screen data including an icon corresponding to the workflow ID of the workflow information in a selectable state as screen data of the workflow list screen for each workflow information stored in the workflow information storage unit 123. In step S203, the content providing unit 112 transmits the generated screen data to the content acquisition unit 211.

In response to a receiving of the screen data by the content acquisition unit 211, the content display unit 212 displays the workflow list screen based on the screen data in step S204. The user can grasp the workflows that can be selected as the execution target by referring to the workflow list screen.

In response to a selection by the user of one of the workflows as the execution target, the content acquisition unit 211 transmits a screen information acquisition request of the selected workflow (hereinafter referred to as a “target workflow”) to the content providing unit 112 of the information processing apparatus 10 in step S205. The acquisition request includes a workflow ID of the target workflow (hereinafter referred to as a “target workflow ID”) and the device type of the target device 20.

In response to receiving the acquisition request, the content providing unit 112 executes the screen information generation process in step S206, based on the screen configuration information stored in the screen configuration information storage unit 122 in association with the target workflow ID included in the acquisition request, the device type included in the acquisition request (hereinafter referred to as a “target device type”), and the user ID of the user related to the acquisition request (hereinafter referred to as a “target user ID”). The screen information refers to information to which control information according to the device type of the target device 20 and the execution state of the target workflow is added to the screen configuration information. Details of the screen information generation process is described below. In the present embodiment, the execution state of the target workflow indicates a state regarding whether the target workflow is on standby or not.

In step S207, the content providing unit 112 transmits the generated screen information to the target device 20. In response to receiving the screen information by the content acquisition unit 211 of the target device 20, the content display unit 212 executes the screen display process of the target workflow based on the screen information in step S208.

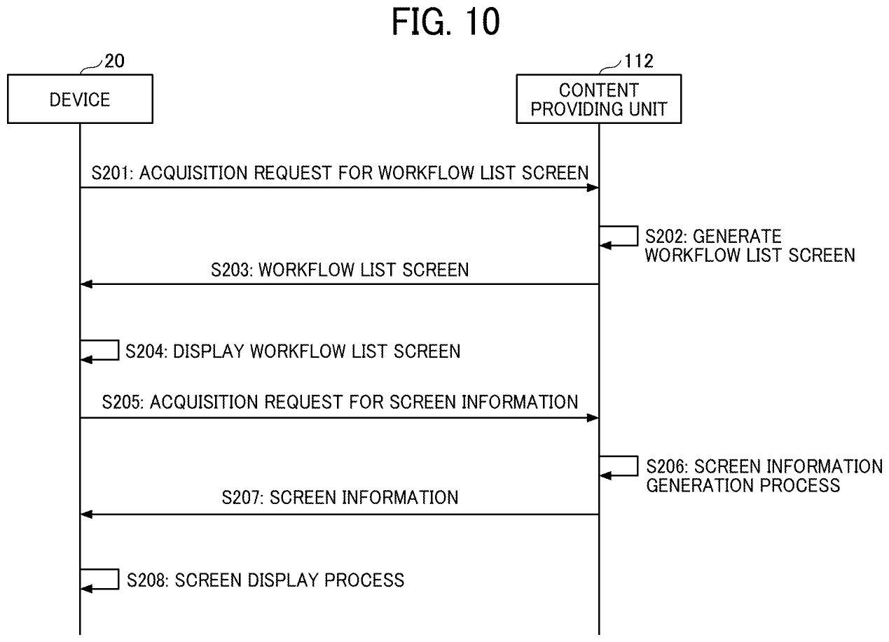

The details of step S206 is described in the following. FIG. 11 is a flowchart illustrating an example of a screen information generation process.

In step S301, the content providing unit 112 acquires the screen configuration information stored in the screen configuration information storage unit 122 associated with the target workflow ID. In step S302, the content providing unit 112 refers to the status storage unit 124 and determines whether the target workflow is on standby or not. As described below, when a workflow is on standby, information indicating that the workflow is on standby (hereinafter referred to as “standby information”) is stored in the status storage unit 124 in association with the workflow ID of the workflow and the user ID of the user related to the execution request source of the workflow. Accordingly, in step S302, the content providing unit 112 determines whether the target workflow is on standby by checking whether the standby information is stored in the status storage unit 124 associated with the target workflow ID and the target user ID.

In the case the target workflow is not on standby (NO in step S302), the content providing unit 112 identifies the component related to the first component definition in the target workflow information as an execution target in step S303. According to the target workflow information illustrated in FIG. 8, the PDF conversion component is identified as the execution target. On the other hand, in the case the target workflow is on standby (YES in step S302), the content providing unit 112 identifies the component to be executed based on the standby information stored in the status storage unit 124 in association with the target workflow ID and the target user ID in step S304. The standby information includes identification information of the standby component on standby. Accordingly, the standby component is identified as the execution target.

Following step S303 or S304, the content providing unit 112 identifies the device type allowed to execute the component identified as the execution target in step S305. The device type allowed to execute the component is identified by referring to the component definition related to the component in the target workflow information.

Specifically, the component identified as the execution target for the target workflow is the PDF conversion component when the screen information acquisition request for the first execution request of the target workflow is requested (when there is no standby information for the target workflow). Accordingly, the content providing unit 112 identifies the device type in which the execution of the PDF conversion component is allowed with reference to the component definition d1 in FIG. 8. In the example of FIG. 8, the component definition d1 does not include information that limits the device types (execution agents) that are allowed to execute the PDF conversion component. In this case, the content providing unit 112 identifies all device types (“MFP”, “PC”, “mobile” in the present embodiment) as the device types that are allowed to execute the PDF conversion component.

On the other hand, at the time of requesting acquisition of screen information for the second execution request of the target workflow (when there is no standby information regarding the target workflow), the component on standby is identified as the component to be executed. Accordingly, the content providing unit 112 refers to the component definition d5 of FIG. 9 to identify the device type in which the execution of the standby component is allowed. In the example of FIG. 9, the component definition d5 includes information indicating that the execution agent is limited to the MFP in the execute element. In this case, the content providing unit 112 identifies the MFP as the device type allowed to execute the component.

In step S306, the content providing unit 112 generates screen information including the screen configuration information acquired in step S301 and the device type identified in step S305.

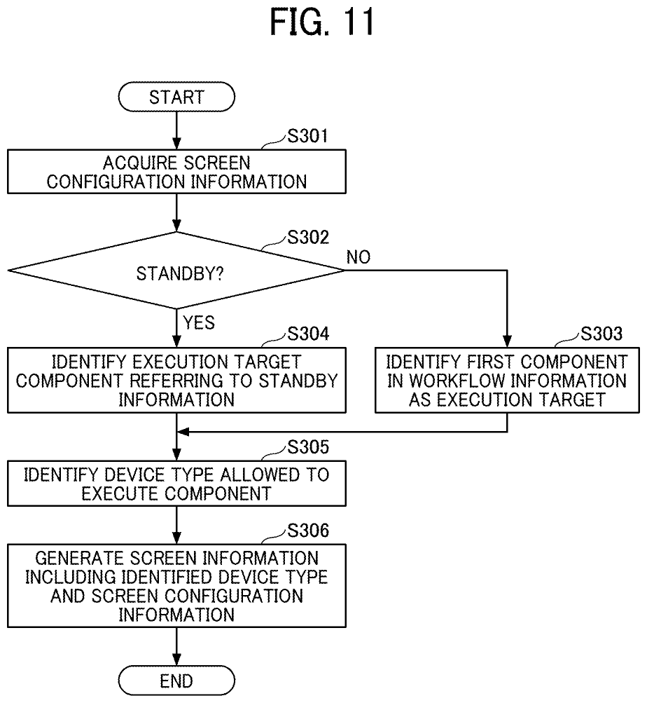

FIG. 12 is a diagram illustrating an example of the screen information. In FIG. 12, the screen information g1 on the left side is an example of the screen information generated at the time of the screen information acquisition request for the first execution request, and the screen information g2 on the right side is an example of the screen information generated at the time of the screen information acquisition request for the second execution request.

The screen information g1 and g2 include a type element e11, a uiParts element e12, a flow element e13, and the like. The value of the type element e11 indicates a type of the target workflow. The type of the target workflow (hereinafter referred to as a “workflow type”) is information to distinguish whether the target workflow is executed by inputting the data uploaded from the device 20 or the data downloaded from the external storage system 40 is output to the device 20. The former workflow type is called “scan”, and the latter workflow type is called “print”. Since the target workflow is executed by inputting the data uploaded from the device 20, the value of the type element e11 is “scan”. The value of the type element e11 is identified based on the target workflow information. For example, when the first component of the target workflow indicated by the target workflow information is a component that assumes the input of data uploaded from the device 20, the content providing unit 112 determines that the workflow type of the target workflow is “scan”.

The uiParts element e12 is the screen configuration information.

The flow element e13 includes a url element, a status element, and an agent element. The value of the url element is a Uniform Resource Locator (URL) for the target workflow information.

The value of the status element is a value indicating whether the target workflow is on standby or not. “None” indicates that the target workflow is not on standby, and “keep” indicates that the target workflow is on standby. At the time of the screen information acquisition request for the first execution request (hereinafter referred to as a “first screen information acquisition request”), the target workflow is not on standby, and the value of the status element in the screen information g1 corresponding to the first screen information acquisition request is none. On the other hand, since the target workflow is on standby at the time of the screen information acquisition request for the second execution request (hereinafter referred to as a “second screen information acquisition request”), the value of the status element in the screen information g2 corresponding to the second screen information acquisition request is keep.

The value of the agent element is the device type that is allowed to execute the component. As described in step S305 of FIG. 11, since MFP, PC, and mobile are identified as the device types for which execution is allowed at the time of the first screen information acquisition request, the value of the agent element in the screen information g1 corresponding to the first screen information acquisition request is a value indicating these device types. On the other hand, since MFP is identified as the device type for which execution is allowed at the second screen information acquisition request, the value of the agent element in the screen information g2 corresponding to the second screen information acquisition request is MFP.

The content providing unit 112 sets the value of the agent element of the screen information based on the target workflow information and changes the processing to be executed for the component (processing unit) to be executed based on the device type of the execution request source of the target workflow.

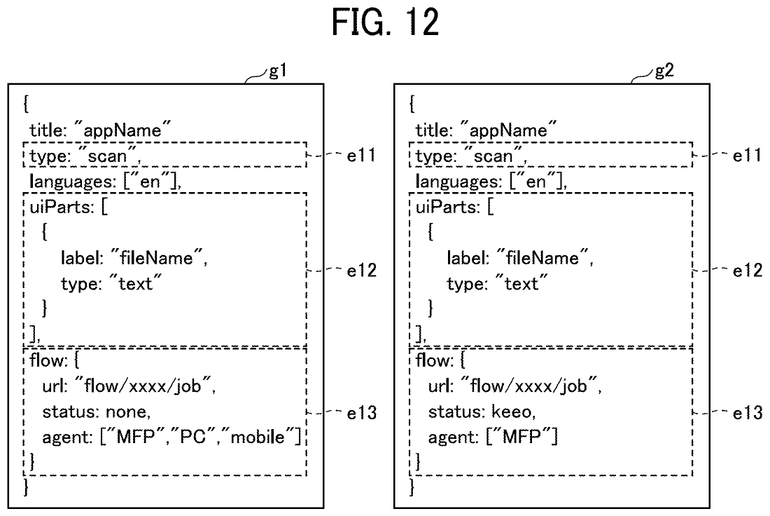

The details of step S208 of FIG. 10 are described in the following. FIG. 13 is a flowchart illustrating an example of a screen display process.

In step S401, the content display unit 212 refers to the agent element in the flow element of the received screen information (FIG. 12) and determines whether the target device 20 is allowed to execute the target workflow. Specifically, the content display unit 212 determines that the target device 20 is allowed to execute the target workflow in the case the value of the agent element includes the device type of the target device 20. On the other hand, in the case the value of the agent element does not include the device type of the target device 20, the content display unit 212 determines that the target device 20 is not allowed to execute the target workflow. Based on such a determination, the content display unit 212 changes the processing to be executed for the processing unit to be executed in the information processing apparatus 10 based on the device type to which the target device 20 belongs. The device type of the target device 20 is stored in, for example, the ROM 33, NVRAM 34, or HDD 35 of the target device 20.

In the case the target device 20 is not allowed to execute the target workflow (NO in step S401), the content display unit 212 displays an error screen in step S402.

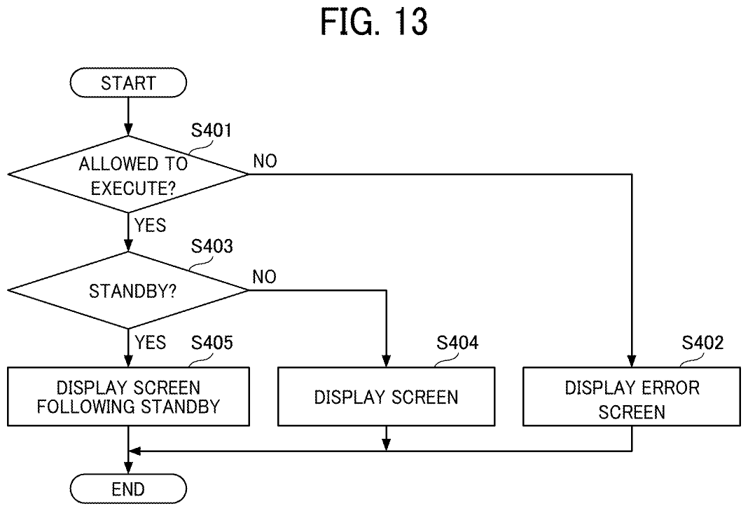

FIG. 14 is a diagram illustrating an example of the error screen. The error screen 530 illustrated in FIG. 14 is an example of the error screen displayed when the device type allowed to execute the target workflow is MFP and the device type of the target device 20 is not MFP. According to the screen information g2 illustrated in FIG. 12, when the target workflow is on standby, the device type allowed to execute the target workflow is MFP. In this case, when the device type of the target device 20 is other than MFP, the error screen 530 is displayed. The error screen 530 includes a message prompting execution from the device 20 belonging to the device type indicated by the value of the agent element of the screen information.

On the other hand, in the case the target device 20 is allowed to execute the target workflow (YES in step S401), the content display unit 212 refers to the status element of the flow element e13 of the screen information and determines whether the target workflow is in the standby state in step S403. The content display unit 212 determines that the target workflow is on standby in the case the value of the status element is keep, and that the target workflow is not on standby in the case the value of the status element is none.

Based on the determination that the target workflow is not on standby (NO in step S403), the content display unit 212 displays a screen based on the screen configuration information (uiParts element e11) included in the screen information in step S404.

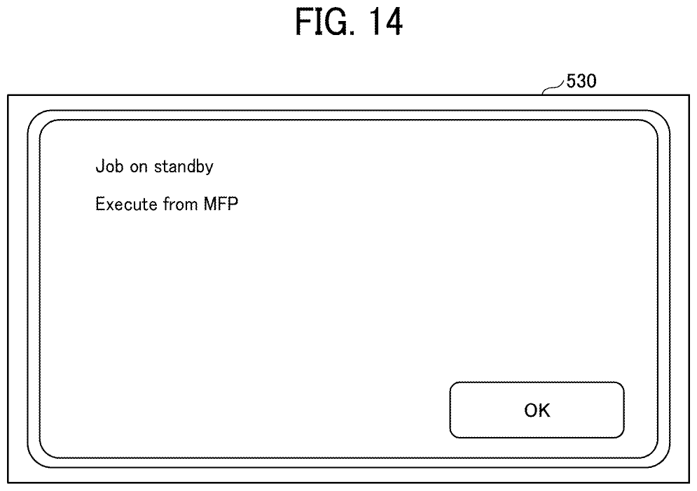

FIG. 15 is a diagram illustrating an example of a screen based on the screen configuration information. In FIG. 15, a screen 540a illustrates an example of the screen displayed in the case the device type of the target device 20 is MFP. A screen 540b illustrates an example of the screen displayed in the case the device type of the target device 20 is other than MFP. The screens 540a and 540b are simply called “screen 540” when the two screens are not distinguished. The screen 540 includes a label 541, a text box 542, a start button 543, and the like.

The label 541 is a screen element that displays the character string (“fileName”) designated as a value of the label element e12 in the uiParts element of the screen information (FIG. 12).

The text box 542 is a screen element corresponding to a value (“ext”) designated in the type element e12 in the uiParts element of the screen information (FIG. 12). The value “ext” of the type element e12 indicates a text box.

The start button 543 is a button that the content display unit 212 displays as a default screen element.

The screen 540 is a screen for allowing the user to enter a name given to the data (file) to be uploaded to the information processing apparatus 10 as an input for the target workflow. The screen 540a corresponding to the device type MFP further includes a setting value display area 544 for inputting (scanning) the data, a button 545 for transitioning to the setting value setting screen, a button 546 for displaying the execution history, and the like.

In response to the user inputting the file name of the data to be uploaded in the text box 542 and pressing of the start button 543, the execution request unit 213 of the target device 20 executes the data input process and assigns the character string (file name) input to the text box 542 to the data input in the input process. The execution request unit 213 transmits an execution request of the target workflow including the data to the information processing apparatus 10. The workflow execution control unit 113 of the information processing apparatus 10 starts the execution process of the target workflow in response to the execution request.

Here, the data input process is an example of scanning an image from a paper document in the case the device type of the device 20 is the MFP. In the case the device type is a device 20 other than the MFP, reading data from a local file and inputting image data by a digital camera possessed by the device 20 are examples of the input process.

On the other hand, when the target workflow is on standby (YES in step S403), the content display unit 212 displays a screen for receiving an execution instruction of the component (processing unit) after standby in the target workflow in step S405.

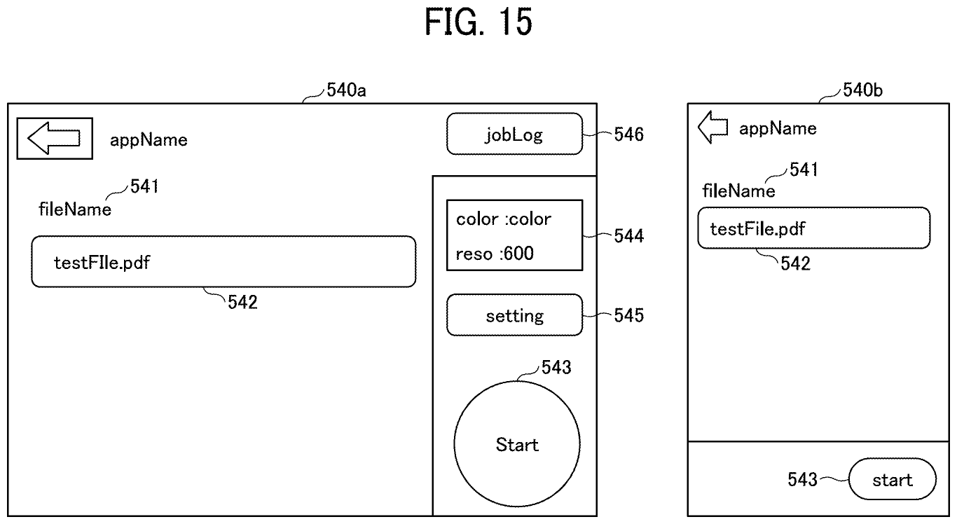

FIG. 16 is a diagram illustrating an example of a screen for receiving an execution instruction after standby. In the present embodiment, the standby component in the target workflow is a download component. Also, in the present embodiment, downloading the data by the device 20 indicates causing the device 20 to print the data. Therefore, the screen 550 of FIG. 16 includes screen elements for receiving settings regarding printing conditions of data downloaded by the device 20. In the target workflow, since the data to be downloaded is the data designated on the screen 540 of FIG. 15 related to the first execution request, the data to be downloaded may not be designated.

In response to the user setting the print conditions on the screen 550 and pressing the start button 551, the execution request unit 213 transmits the (second) execution request for the target workflow to the information processing apparatus 10. The workflow execution control unit 113 of the information processing apparatus 10 cancels the standby of the target workflow and restarts the execution process of the target workflow in response to the execution request.

A process executed by the information processing apparatus 10 in response to the execution request of the target workflow transmitted by the execution request unit 213 of the target device 20, initiated by the pressing of the start button 543 of FIG. 15 or the start button 551 of FIG. 16, is described in the following.

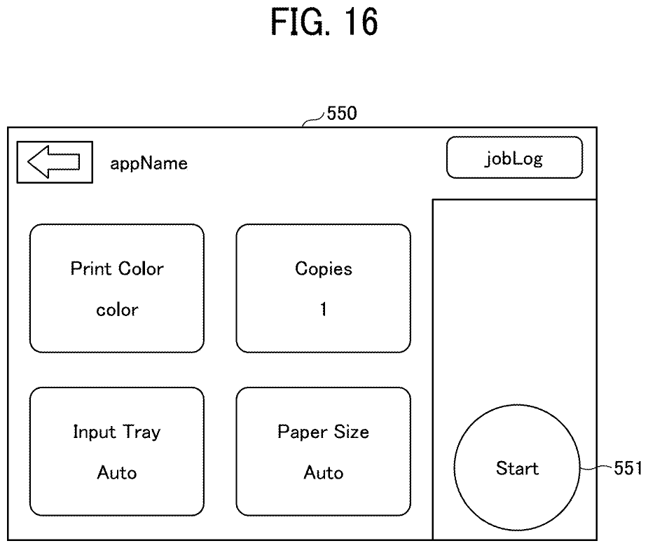

FIG. 17 is a flowchart illustrating an example of a workflow execution control process.

In step S501, the workflow execution control unit 113 determines whether the target workflow is on standby in response to the execution request of the target workflow (hereinafter referred to as a “target execution request”). Whether the target workflow is on standby is determined based on whether the standby information corresponding to the target workflow is stored in the status storage unit 124. The standby information corresponding to the target workflow is the standby information associated with the target workflow ID and the target user ID. The target workflow ID and the target user ID are included in, for example, the target execution request.

In the case the standby information corresponding to the target workflow is not stored, the target workflow is determined not on standby (NO in step S501), the workflow execution control unit 113 assigns 1 to the variable i in step S502. The variable i is a variable for identifying the component (processing unit) to be executed in the target workflow.

Assigning 1 to the variable i indicates that the first component is the execution target. In step S504, the workflow execution control unit 113 determines whether the i-th component is the standby component in the target workflow information (FIGS. 8 and 9). The “i-th” indicates that the order of component definitions in the target workflow information is the “i-th”. Whether the i-th component is the standby component is determined by whether the value of the name element of the i-th component definition is standby or not.

Based on the determination that the i-th component is not the standby component (NO in step S504), the workflow execution control unit 113 determines whether the i-th component is a branch component or not in step S505.

Based on the determination that the i-th component is not the branch component (NO in step S505), the workflow execution control unit 113 executes the component by inputting an execution instruction to the program corresponding to the i-th component in step S506. The component executes the processing unit specific to the component by inputting data such as input data (data uploaded from the target device 20) received along with the target request or the processing results of each component before the i-th component. For example, in the case the i-th component is the PDF conversion component, PDF data is generated based on the data uploaded from the target device 20. In step S507, the workflow execution control unit 113 adds 1 to the variable i, and proceeds to step S511.

On the other hand, based on the determination that the i-th component is the branch component (YES in step S505), the workflow execution control unit 113 identifies the branch destination component based on the component definition d2 (FIG. 8) of the branch component in step S508. Specifically, the workflow execution control unit 113 identifies the branch destination component based on the branch condition indicated by the conditions element in the component definition d2. In FIG. 8, the condition element indicates a branch condition such as “when the execution agent is equal to the MFP, the process proceeds to the two-dimensional bar code assignment (MFP), and when not, the process proceeds to the two-dimensional bar code assignment”. In the case the value of the parameter indicating the device type of the target device 20 included in the target execution request is MFP, the workflow execution control unit 113 identifies the two-dimensional bar code assignment (MFP) component as the branch destination. In the case the value of the parameter is other than MFP, the two-dimensional bar code assignment component is identified as the branch destination. The workflow execution control unit 113 changes the processing to be executed for the processing unit of the branch destination based on the device type to which the target device 20 belongs.

In step S509, the workflow execution control unit 113 executes the component by inputting an execution instruction to the program corresponding to the component identified as the branch destination. In the case of the target workflow, the branch destination of the branch component is the two-dimensional bar code assignment (MFP) component or the two-dimensional bar code assignment component. As mentioned above, these two components are the same except for the parameters. Accordingly, the two-dimensional bar code assignment is assigned to the PDF data generated by the PDF conversion component regardless of the branch destination. In step S510, the workflow execution control unit 113 adds the number of candidates+1 for the branch destination of the i-th component which is the branch component to the variable i, and proceeds to step S511. In the case of the target workflow, the number of branch destination candidates is 2. Accordingly, 2+1=3 is added to i.

In step S511, the workflow execution control unit 113 determines whether the i-th component definition is included in the target workflow information. In the case there is no i-th component definition (NO in step S511), the target workflow is terminated. In the case there is an i-th component definition (YES in step S511), the workflow execution control unit 113 repeats step S504 and subsequent steps.

In step S504, in the case the i-th component is the standby component (YES in step S504), the workflow execution control unit 113 stores the value of the variable i (hereinafter referred to as a “standby position”), the target workflow ID, the target user ID, the current time (hereinafter referred to as “start time”), and the time after the standby time of the standby component elapses from the start time (hereinafter referred to as a “standby period”), the input data, the standby information including the processing result by each component before the i-th component in the status storage unit 124 in step S512, and terminates the processing of FIG. 17. Here, the value of the variable i indicates the order of the standby components. Regarding the target workflow, the processing result by each component before the i-th component is the identification information of the upload destination of the data (data to which the two-dimensional bar code assignment is given) by the upload component (hereinafter, referred to as “upload destination information”) is also included.

From the user's point of view, the target workflow seems to be completed by uploading the data by pressing the start button 543 on the screen 540 of FIG. 15. In response to a specific operation by the user on the same device 20 as the target device 20 or a device 20 different from the target device 20, the process described with reference to FIG. 10 is executed again. In this case, step S205 is the second screen information acquisition request. As a result, in the case the device type of the device 20 on which the specific operation has been performed (hereinafter, the device 20 is referred to as a “target device 20”) is MFP, the target device 20 displays the screen 550 illustrated in FIG. 16 and in the case the device type of the target device 20 is other than MFP, the target device 20 displays the error screen 530 illustrated in FIG. 14.

In response to pressing of the start button 551 on the screen 550 by the user, the target device 20 transmits an execution request for the target workflow (hereinafter referred to as a “target execution request”) to the information processing apparatus 10.

In this case, the standby information corresponding to the target workflow is stored in the status storage unit 124.

In the case the current time does not exceed the “standby period” included in the standby information, the workflow execution control unit 113 determines that the target workflow is on standby (YES in step S501). As a result, the workflow execution control unit 113 assigns the standby position included in the standby information to the variable i in step S503 and executes step S504 and subsequent steps. Therefore, in this case, the target execution request corresponds to the second execution request. In the present embodiment, in step S504 and subsequent steps, the download component is executed in step S506. The download component acquires data from the upload destination indicated by the upload destination information included in the standby information and transmits the data to the target device 20. As a result, the target device 20 prints the data. Since there is no i-th component definition in step S511 after the execution of the download component (NO in step S511), the workflow execution control unit 113 deletes the standby information and terminates the target workflow.

Even when the standby information corresponding to the target workflow is stored in the job storage unit in step S501, in the case the current time has passed the standby period included in the standby information, the workflow execution control unit 113 cancels the execution of the target workflow. Specifically, the workflow execution control unit 113 changes the standby information into cancellation information and stores the cancellation information in the status storage unit 124. The cancellation information may include all information of the original standby information, or may include just the target workflow ID, the target user ID, the start time, and the standby period. Then, the workflow execution control unit 113 determines that the target workflow is not on standby (NO in step S501). Accordingly, the workflow execution control unit 113 executes step S502 and subsequent steps. In this case, the target execution request corresponds to the first execution request.

The device 20 may display a list of standby workflows and a list of workflows whose execution has been canceled (hereinafter referred to as a “cancellation workflow”) based on the standby information and cancellation information.

For example, in response to input of a display instruction for a list of standby workflows to a certain device 20 (hereinafter referred to as a “target device 20”), the content acquisition unit 211 transmits to the information processing apparatus 10 an acquisition request for the list of standby workflows including the user ID of the user of the target device 20. The content providing unit 112 of the information processing apparatus 10 acquires standby information including the user ID from the status storage unit 124. The content providing unit 112 may acquire just the standby information that includes the device type to which the target device 20 belongs as the executable device type among the applicable standby information in the component definition of the standby component in the workflow information corresponding to the workflow ID included in the standby information. That is, the standby information related to the executable workflow may be acquired exclusively from the target device 20. The content providing unit 112 generates screen data of the standby workflow list screen based on the acquired standby information and transmits the screen data to the content acquisition unit 211. In response to a receiving of the screen data by the content acquisition unit 211, the content display unit 212 displays the standby workflow list screen based on the screen data.

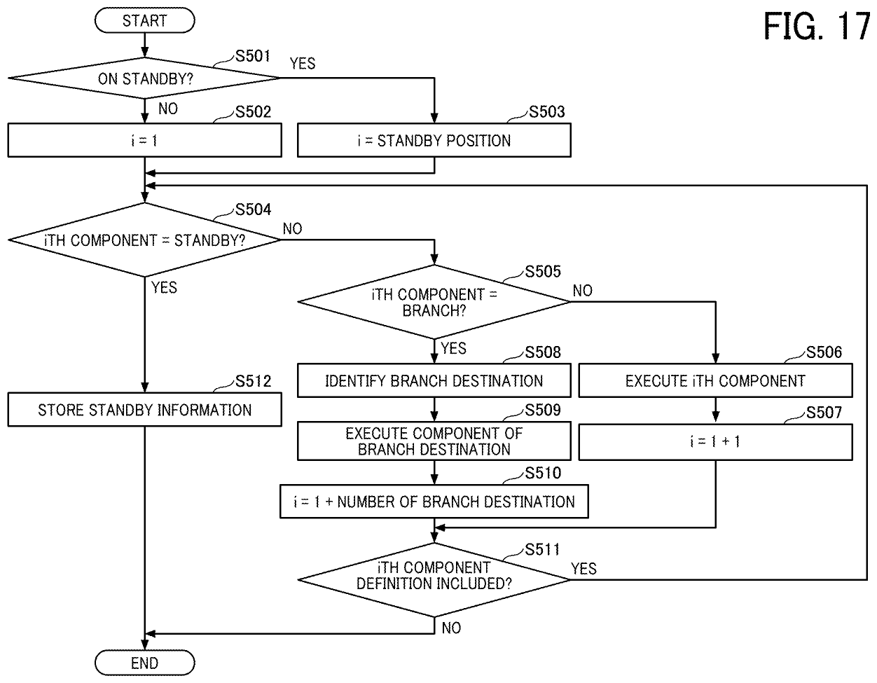

FIG. 18 is a diagram illustrating an example of the standby workflow list screen. As illustrated in FIG. 18, the standby workflow list screen 560 includes a workflow name, a start time, a standby period, and the like for each standby workflow.

In response to a selection of a “link” button attached next to the workflow name, the workflow information related to the workflow name is displayed.

The user can confirm the list of the current standby workflow by referring to the standby workflow list screen 560.

Further, in response to input of the display instruction of a cancellation workflow list to the target device 20, the content acquisition unit 211 sends a request to acquire the cancellation workflow list including the user 1D of the user of the target device 20 to the information processing apparatus 10. The content providing unit 112 of the information processing apparatus 10 acquires the cancellation information including the user ID from the status storage unit 124.

The content providing unit 112 may acquire the cancellation information that includes the device type to which the target device 20 belongs exclusively as the executable device type among the applicable standby information in the component definition of the cancellation component in the workflow information corresponding to the workflow ID included in the cancellation information. That is, the cancellation information related to the workflow that can be executed may be acquired exclusively from the target device 20. The content providing unit 112 generates screen data of a cancellation workflow list screen based on the acquired cancellation information and transmits the screen data to the content acquisition unit 211. In response to a receiving of the screen data by the content acquisition unit 211, the content display unit 212 displays the cancellation workflow list screen based on the screen data.

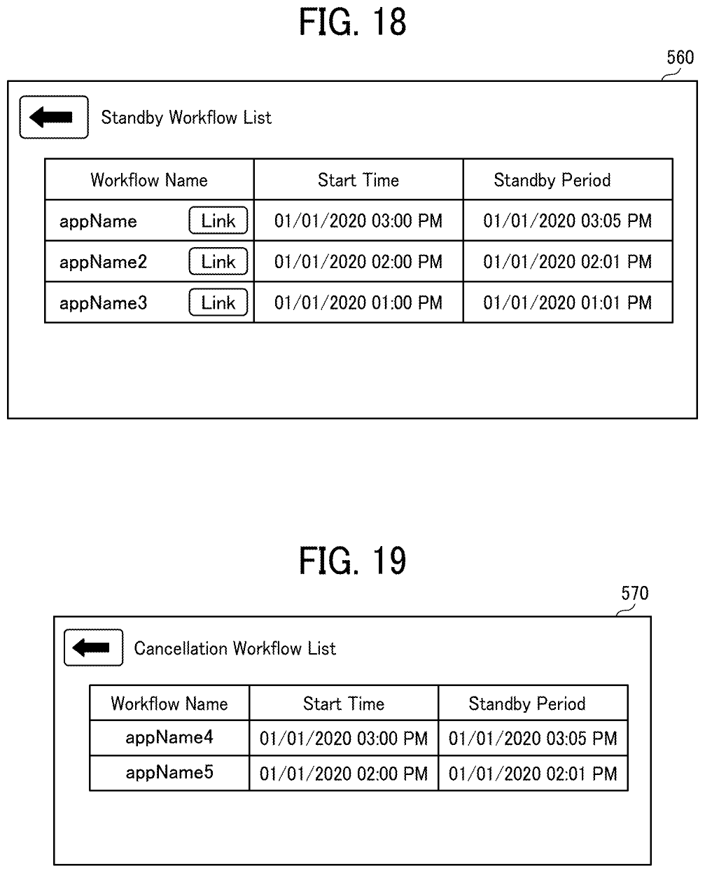

FIG. 19 is a diagram illustrating an example of the cancellation workflow list screen. As illustrated in FIG. 19, the cancellation workflow list screen 570 includes the workflow name, the start time, the standby period (cancelled time), and the like for each cancellation workflow.

By referring to the cancellation workflow list screen 570, the user can confirm the workflow that has been cancelled because the execution instruction was not given within the standby period.

As described above, according to the present embodiment, the execution content of a part of the processing unit of the same workflow changes based on the device type (execution agent) of the device 20 to which the workflow execution request source belongs. Accordingly, the processing to be executed can be changed based on the type of the requesting device.

The device 20 is not limited to the image forming apparatus as long as the device includes a communication function. The device 20 includes, for example, an output device such as a projector (PJ), an interactive whiteboard (a whiteboard having an electronic whiteboard function capable of mutual communication (IWB)), a digital signage, a head up display (HUD) device, an industrial machine, an imaging device, a sound collecting device, a medical device, a network home appliance, a notebook PC, a mobile phone, a smartphone, a tablet terminal, a game console, a personal digital assistant (PDA), a digital camera, a wearable PC, a desktop PC, and the like.

The apparatuses or devices described in the present embodiment are merely one example of plural computing environments that implement one or more embodiments disclosed herein.

In some embodiments, the information processing apparatus 10 includes multiple computing devices, such as a server cluster. The plurality of computing devices is configured to communicate with one another through any type of communication link, including a network, shared memory, etc., and perform the processes disclosed herein. Similarly, the device 20 may include multiple computing devices configured to communicate with one another.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus comprising:
circuitry configured to:
receive, from a device communicably connected to the information processing apparatus through a network, an execution request for a first processing unit of an ordered set of one or more processing units in a workflow, the execution request indicating change in processing based on multiple device types classified by function;
control execution of the workflow in response to the execution request; and
change the processing to be executed for the first processing unit based on the device type to which the device belongs.

2. The information processing apparatus of claim 1, wherein
the first processing unit is a processing unit that branches the workflow, and the circuitry is further configured to select the processing unit of a branch destination of the first processing unit based on the device type to which the device belongs.

3. The information processing apparatus of claim 1, wherein
the first processing unit is a processing unit that causes execution of the workflow to standby until a second execution request, and the circuitry is further configured to change the processing to be executed for the first processing unit based on the device type to which the device related to the second execution request belongs.

4. An information processing system comprising:
a device; and
an information processing apparatus communicably connected to the device, the information processing apparatus including:
circuitry configured to:
receive, from the device, an execution request for a first processing unit of an ordered set of one or more processing units in a workflow. The execution request indicating change in processing based on multiple device types classified by function;
control execution of the workflow in response to the execution request; and
change the processing to be executed for the first processing unit based on the device type to which the device belongs.

5. An information processing method comprising:
receiving, from a device communicably connected to the information processing apparatus through a network, an execution request for a first processing unit of an ordered set of one or more processing units in a workflow, the execution request indicating change in processing based on multiple device types classified by function;
controlling execution of the workflow in response to the execution request; and
changing the processing to be executed for the first processing unit based on the device type to which the device belongs.
